(19) United States
(12) Patent Application Publication
(10) Pub. No.: US 2004/0049617 A1
(43) Pub. Date: Mar. 11, 2004

(54) Method of firmware update by USB interface

(75) Inventors: Shun-Ping Wang, Chia Yi Hsien (TW); Hsin-Chung Luo, Chang Hua Hsien (TW); Tsung-Yi Tseng, Ping Tung Hsien (TW); Chih-Yuan Wu, Hsinchu City (TW)

Correspondence Address: BRUCE H. TROXELL, SUITE 1404, 5205 LEESBURG PIKE, FALLS CHURCH, VA, 22041, US

(73) Assignee: Integrated Circuit Solution Inc.

(21) Appl. No.: 10/654,879

(22) Filed: Sep. 5, 2003

(30) Foreign Application Priority Data
Sep. 5, 2002 (TW) 91120279

(51) Int. Cl. G06F 13/00

(52) U.S. Cl. 710/100

(57) ABSTRACT

A method of updating in system program (ISP) of an USB device is disclosed. After the USB device is connected to a host and its attribute is recognized by the host, the USB device configuration is set. The microprocessor (mp) in USB device executes the ISP codes stored in the flash memory until a first vendor command “ISP_START” is sent from the host for updating new ISP codes. The mp is then idled. Afterward, the ISP decoder handled a series of vendor commands until a vendor command “ISP_RESET” is retrieved. The series of vender commands include “ISP_INITIAL”, “ISP_ERASE_PAGE”, “ISP_INITIAL”, “ISP_PROGRAM”, “ISP_READ”, and “ISP_RESET” to program new ISP codes. The “ISP_READ” is to verify the codes programmed.

### BACKGROUND OF THE INVENTION

1. Field of the Invention

The present invention relates to a firmware updating on an USB device, and more particularly to a method of updating the firmware on an USB (Universal Serial Bus) device having a microprocessor therein.

2. Description of the Prior Art

Since a USB device having a build-in system program, a microprocessor and a set of descriptor therein, the host can easily enumerate and set a configuration for it. User does not need to set any extra address and IRQ (interrupt request) for this peripheral equipment. Thus, for a user feeling frustrated or even nightmare would be alleviated as the periphery device is an USB device. By contrast, as he (or she) plugs a peripheral device other than USB device into a host, the situation would not be true. Mostly, the host can not recognize the device plugged. In addition, USB devices usually support hot-plugging and provided users with a sufficient satisfied data transfer rate merely with very low power consumption while in connection with a computer. Under the full speed mode, the data transfer rate that USB interface provided is fast enough to transfer those digital music files or compressed image signals. Typical USB devices supporting full speed mode are as follows: digital voice recorder, digital camera, MP3 player, printer, flash driver, scanner etc. Next, the USB devices can also run under low speed mode. Exemplary devices are as mouse and keyboard. Besides, the USB device requires only two transmission lines for data transfer and two for power cords. Consequently, for power, the USB device consumed, a coarse wire or transformers are needlessly.

Owe to the aforementioned benefits, the USB device can provide, the conventional serial port such as RS-232 or the parallel port interface is gradually abandoned by users since USB device provides a better choice. Hence, more and more products use USB port as data transfer interface.

When a USB device is plugged through the USB port, the operating system of the computer (or USB host) will send a standard request such as “Get Descriptor” to the USB device. Then, the USB device should have a decoder that can decode the standard request. Afterward, the USB device delivers a descriptor to the operating system for enumerating the USB device. After that, the operating system executes a series of commands such as “Set Address”, “Set Configuration”, etc. to configure an address for the USB device, the USB device can share the resources from the USB host hereafter.

Generally, that the function of USB device provides depends on the firmware or system program in the erasable programmable flash memory thereof. Then, the build-in microprocessor executes the system program. Without the firmware, the USB device can do nothing.

However, these programming codes do not be modified conveniently. When an USB device is sold to customers from a seller, the firmware of the USB device is usually being used until the USB device is discarded by user, even though, an upgraded version of system program was developed by vendor during the device is still available. The reason just because updating the system code is not an ease thing to do by user

Currently, if we want to update the firmware, one method that was adopted is through a parallel port programming system. The programming rate of a parallel port programming system is much faster, but lots of I/O pins are usually required. Especially when the IC (Integrated Circuit chip was welded on the PCB (Printed Circuit Board), update the program code of the USB devices would be a troublesome business. The other method is utilizing a serial port programming system .by which I/O pin encounter does not become a problem, but the speed is slow. Therefore, the upgrade firmware is still a thing for those skilled engineers.

Consequently, the present invention is to provide a programming method for user who can use it as easy as using an application program of the USB device through an USB port. At that time the user runs a programming command or executes normal commands stored in the firmware is a matter of user desired.

### SUMMARY OF THE INVENTION

A main object of the present invention is to provide a method to update the USB device through an USB port thereof.

The present invention discloses a method about updating the firmware of the USB device. The USB device comprises a microprocessor, an USB ISP (In System Program) decoder, and a flash memory therein. To update the firmware, the USB device, the USB device connects with the host firstly. Thereafter, the host enumerates and configures the USB device and then sets up an address for it after getting a descriptor from the USB device. The USB device can then share the resource of the host computer. The microprocessor of the USB device either executing the commands stored in the firmware or the command sending from the host. While receiving the vendor burning command, ISP_START from the host, the USB device enters into a burning mode. The microprocessor hands over the right of controlling power to the USBSP decoder, A series of burning commands such as ISP_INITIAL and ISP—ERASE_PAGE sent from the host then followed. The ISP_INITIAL is to make sure the flash memory in available and avoid any catastrophe occurring that erases the data in the flash memory cell. The burning command, ISP_ERASE_PAGE, is able to erase one flash memory cell page once.

Thereafter, the burning commands, ISP_INITIAL and ISP_PROGRAM is then followed which programs a new version of the system program to the programmable flash memory. Then the command, ISP_READ, reads the updated program to verify the written data correctness. Finally, the burning command, ISP_RESET is to end the burning mode which returns the rights to the microprocessor. And then the microprocessor will process according to the updated system codes.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows hardware controlling block diagram of the USB burning system according to the present invention.

FIG. 2 shows a flow chart of the normal and the burning commands according to the present invention.

FIG. 3a is a table list about ISP request commands and formats thereof according to the present invention.

FIG. 3b is a table list about ISP request commands and corresponding values according to the present invention.

FIG. 4 shows controlling flow chart of the USB burning system software according to the present invention.

### DESCRIPTION OF THE PREFERRED EMBODIMENT

As described in the background of the invention, the microprocessor of the USB device operates according to the system program command fetched from the firmware of the USB device. The user can operate a new function only when the functional relative program had built in the firmware. Besides, for the complicated burning procedures, the user won't update the system program even a new version had provided by the vender. The present invention thus provides a new method to make the firmware updating easily. What the user has to do is just connecting the host with the USB device and assigning burning commands from the host to the USB device.

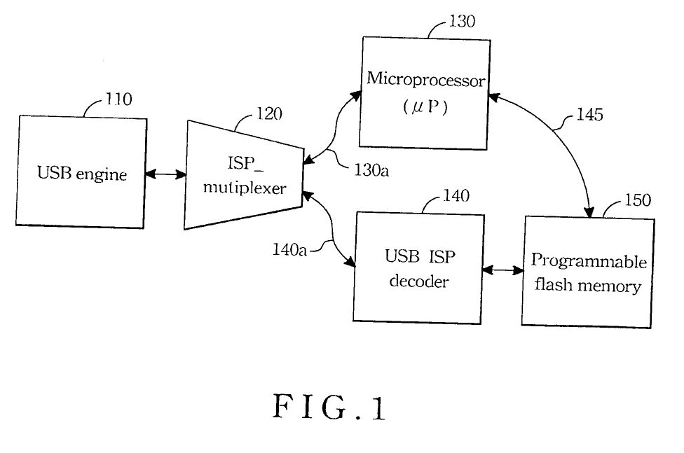

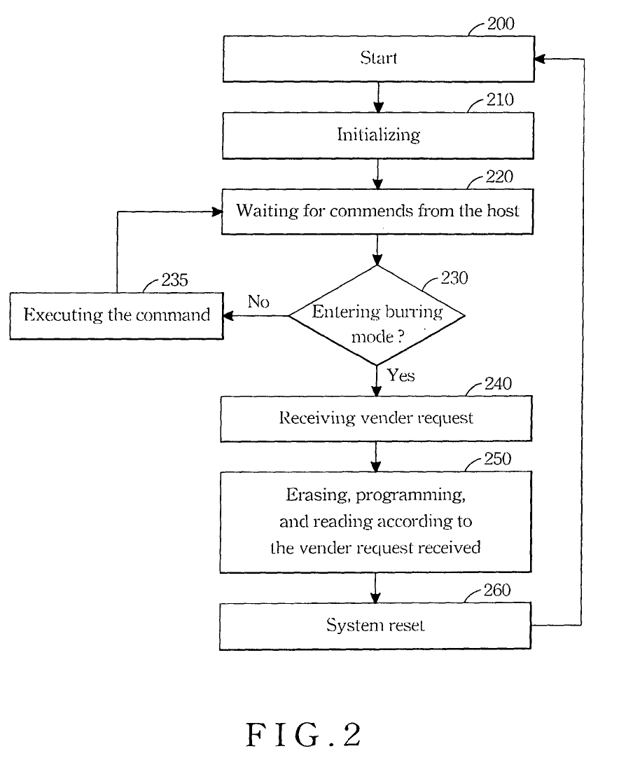

Referring to FIG. 1, it shows a hardware controlling block diagram of the burning system in accordance with the present invention. The burning system comprises an USB engine 110, an ISP (In System Program)_multiplexer 120, a microprocessor 130, an USB ISP decoder 140, and a programmable flash memory 150. Refer to FIG. 2, which shows a flow chart of the burning procedures according to the present invention. In the beginning, starting on step 200, the USB device connects with the host (not shown), and then step 210, the host sends a standard request to the USB engine 110. Afterward, the USB engine 110 generates an interrupt command through the ISP_multiplexer 120 and the normal route 130a to the microprocessor 130. After the microprocessor 130 received the interrupt command, then it responds to the host and requests the host to allot and configure the USB device with an initial address so that the USB device can share the resource of the host. Ordinarily, the first standard request is to get descriptor. The microprocessor 130 decodes the command and sends the descriptor thereof to the host for recognizing the attributes of the USB device connected.

Thereafter, as shown in step 220, the USB device waits for command from the host. Any command received by the USB engine 110 will be read and judged by the microprocessor 130, as shown in step 230. If the command is a normal command relative not to burning, the microprocessor 130 will fetch the system program command of the programmable flash memory 150 via the route 145 and execute it, as shown in step 235. However, as shown in step 240, when a Vendor Request such as ISP_START is sent from the host and received by the microprocessor 130, the ISP_multiplexer 120 will disable the path 130a so that the microprocessor 130 will be isolated and present idle state.

Upon the moment, the microprocessor 130 will hand over its right of command handler to the USB ISP decoder 140 until the USB device be reset thereafter. The ISP_multiplexer 120 will set up a path 140a between the USB engine 110 and the USB ISP decoder 140. Any further commands received by the USB engine 110 will be decode by the USB ISP decoder 140.

Then the USB device is in the burning mode. That is entering the step 250 of performing erasing the codes stored in the flash memory, programming codes into flash memory, and reading out the written codes from the flash memory successively. The detail will describe below:

The USB ISP decoder 140 will decode all the commands in the burning mode from the host and proceed with the burning command so as to update the system program of the programmable flash memory 150.

Apart from the forgoing (1) ISP_START command, the burning mode also includes the following commands (2) ISP_INITIAL, (3) ISP—READ, (4) ISP_ERASE_PAGE, (5) ISP_PROGRAM, and (6) ISP_RESET. The detailed functions of these commands are mentioned below.

ISP_START: When the microprocessor 130 receives such command from the host, the normal mode will switch to the burning mode automatically, and the microprocessor 130 will hand over its right of command handler to the USB ISP decoder 140 and then enter idle state. After that, the USB ISP decoder 140 will handle the right of command handler and wait for the command of burning initialization.

ISP_INTIALL: In the burning mode, before proceeding with programming or erasing to the programmable flash memory cell, the command is executed and confirmed to prevent any undesired action from executing. After the USB ISP decoder 140 decodes ISP_INTIALL command and the programmable flash memory 150 responds followed, the USB ISP decoder 140 will proceed with the programming or erasing command.

ISP_ERASE_PAGE: In the burning mode, before programming, the command is to remove all of the carriers stored in the floating gate, so that the channel between the source and the drain is opened. As a result, when reading the content of the erased cell, a voltage level high is achieved. The command erases the contents of programmable flash memory 150 in a unit of page.

ISP_PROGRAM: In the burning mode, the command is to program the programmable flash memory 150 in a unit of byte.

ISP_READ: In the burning mode, the command is to confirm the correctness of the data programmed in the programmable flash memory 150 by the way of reading the data out once a byte.

ISP_RESET: The command is performed at the last step 260 of the burning mode. In the burning mode, when all the other burning commands, such as programming and reading had finished, the USB ISP decoder 140 will return the right of command handler back to the microprocessor 130 after receiving the command, ISP_RESET. In other words, the route 130a between the USB engine 110 and the microprocessor 130 will recover. Afterward, the microprocessor 130 can execut the updated firmware, no matter the USB device is connected with the host or not, unless another burning commend is received.

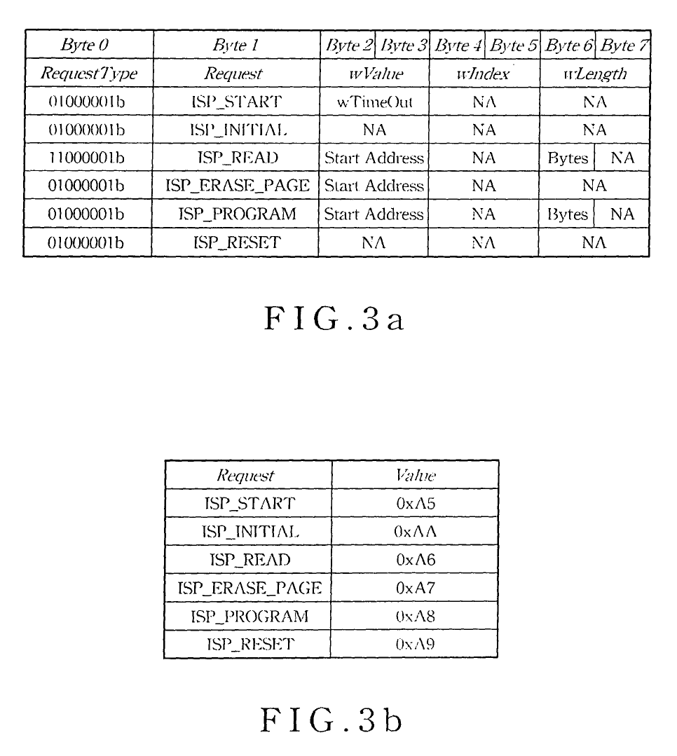

Referring to FIG. 3(a), it shows a table about the format of the ISP request commands mentioned before. All the commands are transaction packets composed of 8 bytes. In the table, “NA” means none. The significant bit of the least byte represents the direction of transaction. As the bit is 0, transaction direction is from the host to the USB device, on the contrary, when the bit is 1, means that it is from the USB device to the host. When the fifth bit is 1, it represents that the command is one of vendor commands. Only the USB ISP decoder 140 can recognize the contents of these commands. The values of the least bit through the fourth bit represent the sorts of interfaces. The least bit equals to 1 represents that the input port of the command is through “endpoint 0”.

The first byte of the six vendor commands mentioned above is about burning. The relationship between the values of the first byte with the corresponding vender commands is shown in FIG. 3(b). When the USB ISP decoder 140 reads the first byte, some action will be executed according to the function of the corresponding commands read. The contents of the second and the third bytes represent different means in accordance with the command corresponded to. For example, ISP_START does not act till waiting time out (wTimeOut). The operation of the commands, ISP_READ, ISP_ERASE_PAGE, and ISP—PROGRAM, need an initial address each. The command ISP—ERASE—PAGE is to erase contents of the programmable flash memory 150 in a unit of page. A page may be 128 bytes but not intended to limit thereto. For example, it may be 64 or 256 bytes per page, so the total byte length of the ISP_ERASE_PAGE pocket described needs not to be limited, and the initial address of the page is enough for the command to operate. On the other hand, the commands, ISP_READ and ISP_PROGRAM, are executed in a unit of byte, so that the byte B6 containing the byte length is necessary.

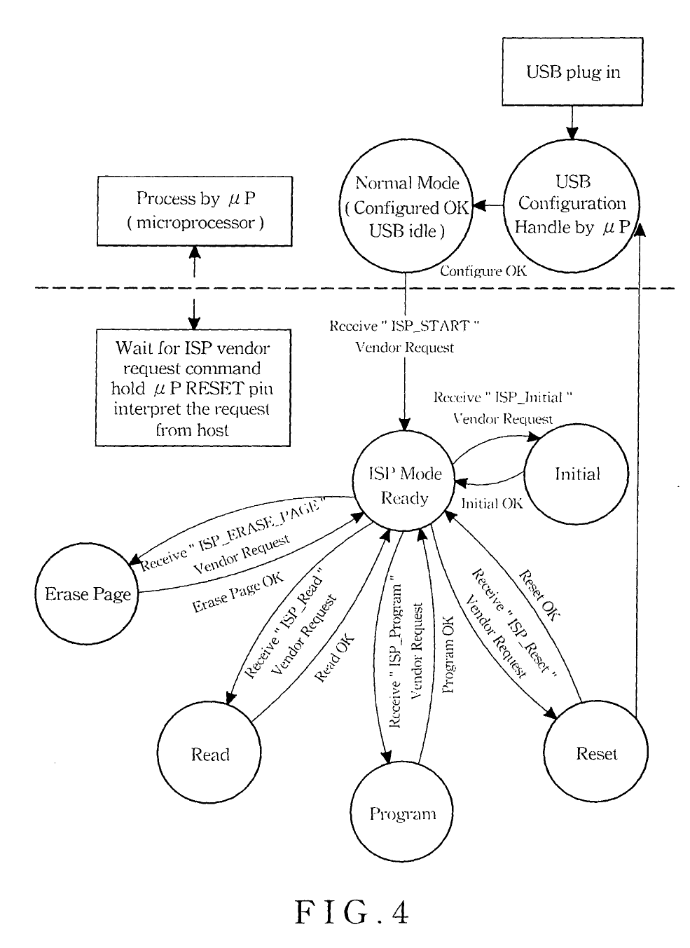

Referring to FIG. 4, it shows the USB burning system software controlling flow chart according to the present invention. In the normal mode, the standard requests from the host and the USB system program commands are all commanded by the microprocessor 130. By contrast, the USB ISP decoder 140 handles the burning commands. When the execution of burning commands finishes, as shown in the figure, the USB device will respond an “OK” message to the host.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest formation so as to encompass all such modifications and similar structure.

What is claimed is:

1. A method of updating a flash memory system program of an USB device, which has a microprocessor and an USB ISP decoder therein, and said method comprises the steps of:
connecting said USB device with a host;
getting a descriptor from said USB device and configuring said USB device by said host;
suspending said USB device and waiting for commands sent from said host;
executing normal commands sent from said host by said microprocessor until a first burning command sent from said host is received;
handing over the right of command hander of said commands from said microprocessor to said USB ISP decoder;
erasing said flash memory while said USB ISP decoder receives and executes burning commands which comprises a confirming command and a erasing command in a series sent from said host;
repeating said step of erasing said flash memory until said contents of all pages of said fresh memory cells being erased;
programming said flash memory cells while said USB ISP decoder receives and executes burning commands which comprises a confirming command and a programming command in a series sent from said host;
repeating said step of programming said flash memory cells until said system program of said flash memory cells are thoroughly updated;
verifying said updated system program of said flash memory cells contents while said USB ISP decoder receives and executes a burning command about reading sent from said host, until said flash memory cells correctness of all said updated contents of said flash memory is verified;
resetting said USB device while said USB ISP decoder receives and executes a burning command about resetting; and
returning said right of command handler to said microprocessor.

2. The method of claim 1 wherein said step of getting a descriptor from the USB device comprises the steps of:
said host sending a standard request to an USB engine of said USB device, receiving said standard request by the USB engine;
generating an interrupt signal to said microprocessor;
sending a descriptor to said host;
configuring said USB device by said host.

3. The method of claim 1 wherein said normal commands further comprises commands of system program in said flash memory cells.

4. The method of claim 1 wherein said first burning command is ISP_START transaction pocket, which contains a waiting time record therein.

5. The method of claim 1 wherein said confirming command is an ISP_INITIAL transaction pocket, which requests said flash memory in response to said USB ISP decoder to indicate said flash memory is ready.

6. The method of claim 1 wherein said erasing command is an ISP_ERASE_PAGE command transaction pocket having an initial address therein to erase the contents of said flash memory a page once.

7. The method of claim 1 wherein said programming command is an ISP_PROGRAM command transaction pocket having an initial address to program a byte once.

8. The method of claim 1 wherein said burning command about reading is an ISP_READ command transaction pocket, which reads contents of the flash memory cells a byte once.

9. The method of claim 1 wherein said burning command about resetting is an ISP_RESET command.

10. The method of claim 1 wherein said confirming command is the command to prevent said erasing command, programming command from miss executing

11. The method of claim 6 wherein said programming command is to program contents of the flash memory a byte once, as a result, said ISP_PROGRAM needs an initial address thereto program said flash memory cells.

12. The method of claim 7 wherein said ISP_READ is the command executed to read contents out of the flash memory once a byte, as a result, ISP_READ comprises a reading initial address of the flash memory cells.

13. The method of claim 1 wherein said burning commands are transaction pockets which are composed of 8 bytes.
